(19) United States
(12) Patent Application Publication
(10) Pub. No.: US 2026/0149028 A1
(43) Pub. Date: May 28, 2026

(54) ELECTRODE ALIGNMENT UNIT OF SECONDARY BATTERY, ELECTRODE ALIGNMENT SYSTEM OF SECONDARY BATTERY AND ELECTRODE ALIGNMENT METHOD OF SECONDARY BATTERY

(71) Applicant: HANA TECHNOLOGY CO., LTD., Yongin-si (KR)

(72) Inventors: Jeong Seok JEONG, Suwon-si (KR); Soo Yeon JANG, Yongin-si (KR); Hyuk Joong KWON, Osan-si (KR); Young Il SHIN, Ansan-si (KR); Eun Mi LEE, Hwaseong-si (KR)

(21) Appl. No.: 19/370,029

(22) Filed: Oct. 27, 2025

(30) Foreign Application Priority Data
Nov. 25, 2024 (KR) 10-2024-0169219

(51) Int. Cl. H01M 10/04; G01N 21/88; G06T 7/70; H04N 23/50

(52) U.S. Cl. CPC H01M 10/0404; G01N 21/8806; G06T 7/70; H04N 23/555; G01N 2021/8835

(57) ABSTRACT

Described are an electrode alignment unit of a secondary battery, an electrode alignment system of a secondary battery, and an electrode alignment method of a secondary battery that prevent defects caused by tilting, etc. of an electrode in subsequent processes by capturing an image of at least one side of the electrode supplied to a first suction part and then aligning the position of the electrode.

### CROSS REFERENCE TO RELATED APPLICATION

The present application claims priority to Korean Patent Applications No. 10-2024-0169219, filed Nov. 25, 2024, the entire contents of which are incorporated herein by reference.

### BACKGROUND

### Technical Field

The present disclosure relates to an electrode alignment unit of a secondary battery, an electrode alignment system of a secondary battery, and an electrode alignment method of a secondary battery and, more particularly, to an electrode alignment unit of a secondary battery, an electrode alignment system of a secondary battery, and an electrode alignment method of a secondary battery that prevent defects caused by tilting, etc. of an electrode in subsequent processes by capturing an image of at least one side of the electrode supplied to a first suction part and then aligning the position of the electrode.

### Description of the Related Art

As the development of electric vehicles, energy storage batteries, robots, and satellites has been actively carried out in recent years, research on secondary batteries, which are high-performance batteries capable of repeated charging and discharging, has been actively conducted. At present, as commercialized batteries, there are a nickel-cadmium battery, a nickel-hydrogen battery, a nickel-zinc battery, a lithium-ion secondary battery, etc. Among these batteries, since the lithium-ion secondary battery is attracting attention because, compared to nickel-based secondary batteries, it hardly causes a memory effect, can be freely charged and discharged, has a very low self-discharge rate, and has high energy density.

Such secondary batteries are formed by sequentially stacking a positive electrode plate, a separator, and a negative electrode plate and immersing them in an electrolyte solution, and in order to manufacture an internal cell stack of these secondary batteries, a method of cutting a negative electrode plate and a positive electrode plate to a required size and alternately stacking the negative electrode plate, a separator, the positive electrode plate, and a separator is utilized. In this case, a process of aligning the position of the electrode including the cut negative electrode plate and the positive electrode plate before supplying the electrode to a stacking device is required.

In this regard, the inventors of the present disclosure present novel electrode alignment unit of a secondary battery, electrode alignment system of a secondary battery, and electrode alignment method of a secondary battery, and detailed descriptions thereof will be given below.

### Related Art Document

(Patent Document 1) Korean Patent Application Publication No. 10-2024-0045631, “Secondary Cell Align System and Control Method Using the Same”.

### SUMMARY

The present disclosure has been made in an effort to solve the problems of the related art described above, and an objective of the present disclosure is to provide an electrode alignment unit of a secondary battery, an electrode alignment system of a secondary battery, and an electrode alignment method of a secondary battery that prevent defects caused by tilting, etc. of an electrode in subsequent processes by capturing an image of at least one side of the electrode supplied to a first suction part and then aligning the position of the electrode.

Another objective of the present disclosure is to provide an electrode alignment unit of a secondary battery, an electrode alignment system of a secondary battery, and an electrode alignment method of a secondary battery that enable an image-capturing part positioned under a light transmission plate to easily capture an image of an electrode on the light transmission plate by providing the light transmission plate at an edge or an end of a first suction part in a first direction.

Another objective of the present disclosure is to provide an electrode alignment unit of a secondary battery, an electrode alignment system of a secondary battery, and an electrode alignment method of a secondary battery that enable the edge or the end of an electrode to be firmly fixed on a first suction part by forming a second plate on a light transmission plate.

Another objective of the present disclosure is to provide an electrode alignment unit of a secondary battery, an electrode alignment system of a secondary battery, and an electrode alignment method of a secondary battery that enable the position of the image-capturing part and/or the lighting unit to be easily changed in accordance with the shape and size of the electrode by providing a first movement guide part that controls movement of the image-capturing part and/or the lighting unit in a first direction.

Another objective of the present disclosure is to provide an electrode alignment unit of a secondary battery, an electrode alignment system of a secondary battery, and an electrode alignment method of a secondary battery that prevent defects in subsequent processes by providing a multi-sheet sensing element that senses whether two or more sheets of electrodes are present on a first suction part.

Another objective of the present disclosure is to provide an electrode alignment unit of a secondary battery, an electrode alignment system of a secondary battery, and an electrode alignment method of a secondary battery that enable an easy layout in a small space by forming a position alignment part in a two-stage stacked configuration

Another objective of the present disclosure is to provide an electrode alignment unit of a secondary battery, an electrode alignment system of a secondary battery, and an electrode alignment method of a secondary battery that enable easy removal of foreign matter remaining on a first suction part by providing a foreign matter removal part.

Another objective of the present disclosure is to provide an electrode alignment unit of a secondary battery, an electrode alignment system of a secondary battery, and an electrode alignment method of a secondary battery that enable fine adjustment of the position of a second suction part in a first direction by providing a position adjustment part.

In order to achieve the objectives, the present disclosure may be accomplished by an embodiment having the following configuration.

According to an embodiment of the present disclosure, an electrode alignment unit of a secondary battery according to the present disclosure includes: a first suction part configured to vacuum-suction an electrode seated on one surface; an image-capturing part configured to capture an image of an electrode on the first suction part; a position alignment part configured to align the position of an electrode seated on the first suction part by adjusting the position of the first suction part; and a control part configured to control driving of the position alignment part.

According to another embodiment of the present disclosure, the first suction part of the electrode alignment unit of a secondary battery according to the present disclosure may include: a suction plate disposed at a center of the first suction part and configured to vacuum-suction an electrode placed on an upper side thereof; and a light transmission plate disposed at an edge and/or an end of the first suction part in one direction and configured to vacuum-suction the electrode.

According to another embodiment of the present disclosure, the suction plate of the electrode alignment unit of a secondary battery according to the present disclosure may include multiple first suction holes on the upper surface, and the light transmission plate may include one or more second suction holes on an upper surface thereof.

According to another embodiment of the present disclosure, the image-capturing part of the electrode alignment unit of a secondary battery according to the present disclosure may capture an image of the electrode seated on the light transmission plate.

According to another embodiment of the present disclosure, the image-capturing part of the electrode alignment unit of a secondary battery according to the present disclosure may include: an image-capturing device disposed under the light transmission plate and configured to capture an image of an electrode on the light transmission plate; a fixing member coupled to the image-capturing device and configured to fix the image-capturing device at a correct position; and a lighting part of a lighting configuration configured to assist in capturing an image of an electrode on the light transmission plate.

According to another embodiment of the present disclosure, the electrode alignment unit of a secondary battery according to the present disclosure may include multiple lighting devices spaced apart from each other adjacent to and under the light transmission plate and disposed to be inclined at a predetermined angle from a floor.

According to another embodiment of the present disclosure, the electrode alignment unit of a secondary battery according to the present disclosure may further include a first movement guide part configured to control movement of the image-capturing part in one direction, wherein the first movement guide part may include: a first guide rail of a rail configuration extending in one direction; and a first linear guide coupled to the first guide rail and configured to move together with the image-capturing part in one direction.

According to another embodiment of the present disclosure, the position alignment part of the electrode alignment unit of a secondary battery according to the present disclosure may include: a drive part; a movement control part disposed over the drive part and configured to receive a driving force from the drive part; a moving part disposed over the drive part and configured to be moved in a horizontal direction by the movement control part; and a second movement guide part disposed on an upper surface and/or a lower surface of the moving part and configured to guide horizontal movement of the moving part.

According to another embodiment of the present disclosure, the position alignment part of the electrode alignment unit of a secondary battery according to the present disclosure may further include: a rotary part rotatably disposed on the moving part or the second movement guide part; and a top plate member having an insertion hole in which an upper portion of the rotary part is inserted, wherein the top plate member may be connected to the first suction part.

According to another embodiment of the present disclosure, the second movement guide part of the electrode alignment unit of a secondary battery according to the present disclosure may include: a first movement guide rail on an upper surface of the moving part; and a second movement guide rail on a bottom surface of the moving part, wherein the first movement guide rail may extend in a direction crossing the second movement guide rail.

According to another embodiment of the present disclosure, the control part of the electrode alignment unit of a secondary battery according to the present disclosure may control driving of the position alignment part by comparing image-capturing information acquired from the image-capturing part with reference coordinate information stored in the control part.

According to another embodiment of the present disclosure, the electrode alignment unit of a secondary battery according to the present disclosure may further include a sensing part configured to sense an electrode seated on the first suction part, wherein the sensing part may include an electrode sensing element configured to sense whether an electrode is present on the first suction part.

According to another embodiment of the present disclosure, the electrode alignment unit of a secondary battery according to the present disclosure may further include a sensing part configured to sense an electrode seated on the first suction part, wherein the sensing part may further include a multi-sheet sensing element configured to sense whether two or more sheets of electrodes are present on the first suction part.

According to another embodiment of the present disclosure, the electrode alignment unit of a secondary battery according to the present disclosure may further include a foreign matter removal part configured to remove foreign matter attached to the first suction part, wherein the foreign matter removal part may include: a fluid spraying part disposed at one side of the first suction part and configured to spray fluid onto the first suction part; and a collecting part disposed at another side of the first suction part and configured to collect foreign matter removed from the first suction part.

According to an embodiment of the present disclosure, an electrode alignment system of a secondary battery according to the present disclosure includes: an electrode alignment unit of a secondary battery; and a discharge unit configured to discharge an electrode on the electrode alignment unit of a secondary battery to the outside when a defective condition is detected in the electrode.

According to another embodiment of the present disclosure, the discharge unit of the electrode alignment system of a secondary battery according to the present disclosure may include: a first drive actuator; a moving part configured to be moved in one direction by driving of the first drive actuator; a second drive actuator coupled to the moving part; and a second suction part connected to the second drive actuator and configured to be vertically moved by driving of the second drive actuator.

According to another embodiment of the present disclosure, the discharge unit of the electrode alignment system of a secondary battery according to the present disclosure may further include a position adjustment part configured to control movement of the second suction part in one direction, wherein the position adjustment part may include: a third drive actuator; a fixing member configured to fix an end of a drive shaft of the third drive actuator; a second linear guide disposed on one surface of the fixing member; and a second guide rail coupled to the second linear guide.

According to another embodiment of the present disclosure, in any one case of a case in which it is determined that the position alignment part cannot align the position of the electrode seated on the first suction part, a case in which it is determined that there is a problem in the shape of the electrode by comparing image-capturing information acquired from the image-capturing part with reference shape information stored in the control part, and a case in which it is determined that two or more sheets of electrodes are seated on the first suction part, the discharge unit of the electrode alignment system of a secondary battery according to the present disclosure may discharge the electrode to the outside from the electrode alignment unit of a secondary battery.

According to an embodiment of the present disclosure, an electrode alignment method of a secondary battery according to the present disclosure includes: fixing an electrode seated on the first suction part by vacuum-suctioning the electrode; acquiring image-capturing information by capturing an image of the electrode seated on the first suction part through the image-capturing part; and controlling driving of the position alignment part by comparing the image-capturing information with reference coordinate information through the control part.

According to another embodiment of the present disclosure, in the electrode alignment method of a secondary battery according to the present disclosure, the electrode alignment unit of a secondary battery may include a foreign matter removal part that includes a fluid spraying part disposed at one side of the first suction part and configured to spray fluid onto the first suction part, and a collecting part disposed at another side of the first suction part and configured to collect foreign matter removed from the first suction part; and the electrode alignment method may further include removing foreign matter on the first suction part through the foreign matter removal part before vacuum-suctioning an electrode on the first suction part.

The present disclosure having the above configuration has the following effects.

The present disclosure has an effect of preventing defects caused by tilting, etc. of an electrode in subsequent processes by capturing an image of the electrode supplied to the first suction part and then aligning the position of the electrode.

Further, the present disclosure has an effect of enabling the image-capturing part positioned under a light transmission plate to easily capture an image of an electrode on the light transmission plate by including the light transmission plate at the edge or end the first direction of the first suction part.

Further, the present disclosure has an effect that the edge or end portions of the electrode are firmly fixed on the first suction part by forming second suction holes in the light transmission plate.

Further, the present disclosure has an effect of enabling easy adjustment of the position of the image-capturing part and/or the lighting part in accordance with the shape and size of an electrode by including a first movement guide part that controls movement of the image-capturing part and/or the lighting part in the first direction.

Further, the present disclosure has an effect of preventing defects in subsequent processes by including a multi-sheet sensing element that senses whether two or more sheets of electrodes are placed on the first suction part.

Further, the present disclosure has an effect of enabling easy layout within a limited space by configuring the position alignment part in a two-stage stacked configuration.

Further, the present disclosure has an effect of enabling easy removal of foreign matter remaining on the first suction part by including a foreign matter removal part.

Further, the present disclosure has an effect of enabling fine adjustment of the position of the second suction part in the first direction by including a position adjustment part.

Even though not clearly stated herein, the effects expected from the technological characteristics of the present disclosure and described in the following description and latent effects should be construed as being described in the specification of the present disclosure.

### BRIEF DESCRIPTION OF THE DRAWINGS

FIG. 1 is a perspective view of an electrode alignment system of a secondary battery according to an embodiment of the present disclosure;

FIG. 2 is a perspective view of an electrode alignment unit of a secondary battery according to FIG. 1;

FIG. 3 is a front view of the electrode alignment unit of a secondary battery according to FIG. 2;

FIG. 4 is a plan view of a first suction part according to FIG. 2;

FIG. 5 is an illustrativeview of a movement guide part according to FIG. 2;

FIG. 6 is an illustrative view of a sensing part according to FIG. 2;

FIG. 7 is a perspective view of a position alignment part according to FIG. 2;

FIG. 8 is a side view of the position alignment part according to FIG. 2;

FIG. 9 is an illustrative view of a foreign matter removal part according to FIG. 2;

FIG. 10 is a perspective view of a discharge unit according to FIG. 1;

FIG. 11 is a front view of the discharge unit according to FIG. 10;

FIG. 12 is a plan view of a second suction part according to FIG. 10; and

FIGS. 13 to 17 are illustrative views for explaining an electrode alignment method of a secondary battery according to an embodiment of the present disclosure.

### DETAILED DESCRIPTION

Hereinafter, embodiments of the present disclosure are described in detail with reference to the accompanying drawings. Embodiments of the present disclosure may be changed in various ways and the range of the present disclosure should be construed on the basis of claims rather than being limited to the following embodiments. The embodiments are provided as reference to more completely explain the present disclosure to those skilled in the art.

As used in the specification, a singular term may include a plural term unless another case is stated in the context. Terms “comprise” and/or “comprising” stated herein specify existence of shapes, numbers, steps, operations, members, elements that are stated herein, and/or a group thereof without excluding existence or addition of one or more other shapes, numbers, operations, members, elements, and/or a group thereof.

Hereafter, it should be noted that when a component (or layer) is disposed on another component (or layer), the component may be disposed directly on the other component or another component(s) or layer(s) may be disposed between the components. Further, when a component is disposed directly one or over another component, another component(s) is not positioned between the components. Further, when a component is positioned “on”, “over”, “under”, “at an upper portion”, “at a lower portion”, “at a side”, or “on a side”, it means a relative positional relationship.

In addition, in the following description, reference numerals may be used to denote components such as “first” and “second,” but it should be noted that the second component does not necessarily depend on the first component, and each component is independent of one another.

As used herein, a statement that one component is “coupled” or “connected” to another component includes not only direct coupling or connection between the components, but also indirect coupling or connection through a third component.

As used herein, the term “electrode” is understood to refer, for example, to an anode plate or a cathode plate.

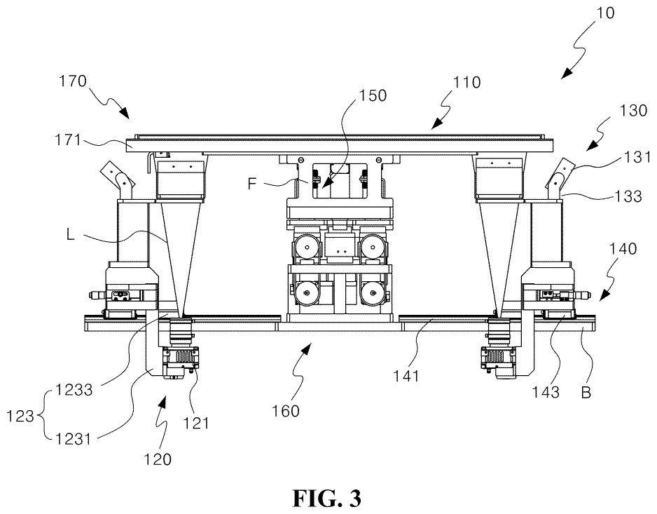

In addition, the longitudinal direction of a first suction part is defined as a “first direction,” and the width direction of the first suction part is defined as a “second direction.” For example, in the front view shown in FIG. 3, the x-axis direction may correspond to the first direction, and the y-axis direction may correspond to the second direction.

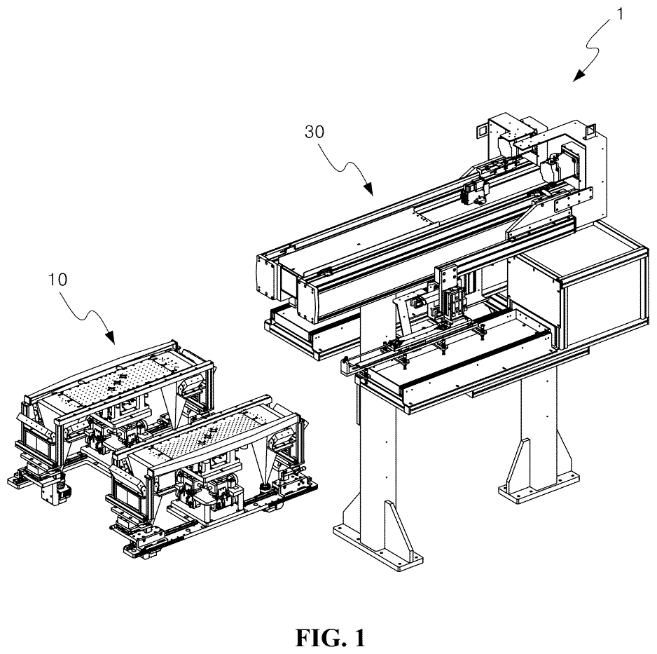

FIG. 1 is a perspective view of an electrode alignment system of a secondary battery according to an embodiment of the present disclosure.

Hereinafter, an electrode alignment system 1 of a secondary battery according to an embodiment of the present disclosure is described in detail with reference to the accompanying drawings.

Referring to FIG. 1, the present disclosure relates to an electrode alignment system 1 of a secondary battery, and more particularly, to an electrode alignment system 1 of a secondary battery that prevents defects caused by tilting, etc. of an electrode 9 in subsequent processes by capturing an image of at least one side of the electrode 9 supplied to a first suction part 110 and then aligning the position of the electrode 9.

To this end, the electrode alignment system 1 of a secondary battery may include an alignment unit 10 and a discharge unit 30. Hereinafter, the alignment unit 10 may also be referred to as an electrode alignment unit 10 of a secondary battery. Further, the discharge unit 30 may be disposed adjacent to the alignment unit 10. For reference, although not shown in the drawing, a stack stage unit for alternately stacking an electrode and a separator may be disposed between a pair of alignment units 10

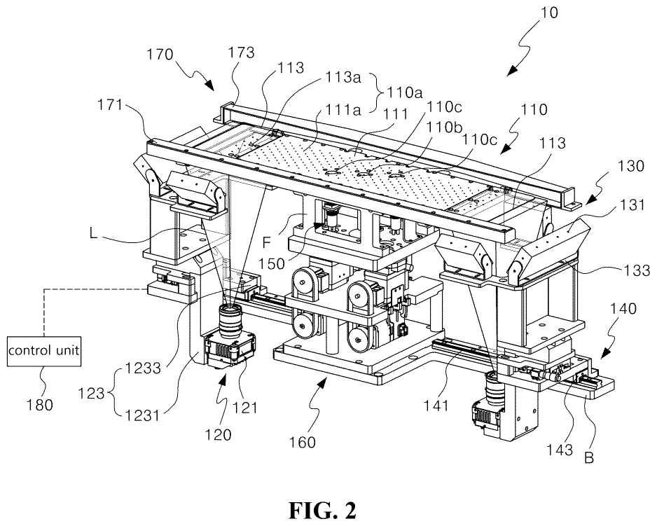

FIG. 2 is a perspective view of an electrode alignment unit of a secondary battery according to FIG. 1 and FIG. 3 is a front view of the electrode alignment unit of a secondary battery according to FIG. 2.

Referring to FIGS. 1 to 3, the alignment unit 10 is configured to align the position of an electrode 9 on a first suction part 110 by capturing an image of at least one side of the electrode 9 seated on the first suction part 110 and then adjusting the position of the first suction part 110. For this purpose, the alignment unit 10 may include the first suction part 110, an image-capturing part 120, a lighting part 130, a first movement guide part 140, a first sensing part 150, a position alignment part 160, a foreign matter removal part 170, and a control part 180.

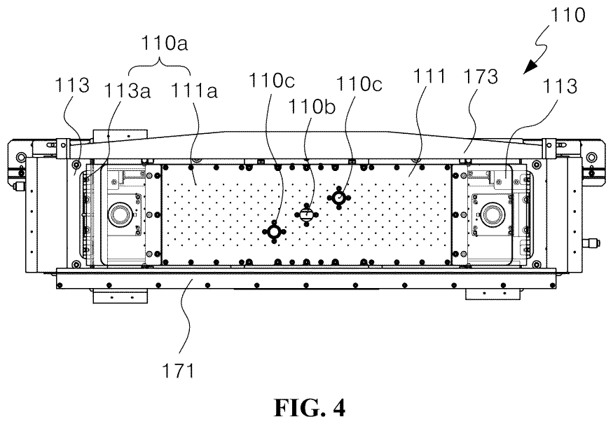

FIG. 4 is a plan view of a first suction part according to FIG. 2.

Referring to FIGS. 2 to 4, the first suction part 110 is configured to vacuum-suction an electrode 9 seated on an upper surface thereof. The first suction part 110 is preferably formed in a plate shape with a substantially flat upper surface. Further, the first suction part 110 is preferably formed at an uppermost side of the alignment unit 10 so that the electrode 9 is easily supplied and discharged. Further, multiple suction holes 110a for easy vacuum suction of the electrode 9 may be formed to be spaced apart from each other in the first suction part 110. The suction holes 110a may be formed to pass through the upper surface of the first suction part 110 in the vertical direction. Each suction hole 110a can be in communication with a vacuum line (not shown). For example, the first suction part 110 has an internal space that is in communication with the vacuum line, and the multiple suction holes 110a are in communication with the internal space, whereby it is possible to fix an electrode 9 seated on the upper surface of the first suction part 110 by vacuum-suctioning the electrode 9. Accordingly, the electrode 9 can be fixed while the first suction part 110 is moved to align the electrode 9.

Further, a first sensing hole 110b and a second sensing hole 110c may be further formed in the first suction part 110 at positions where they do not interfere with the suction holes 110a. The first sensing hole 110b and the second sensing hole 110c may be configured as through-holes passing through the first suction part 110 in the vertical direction. For example, the first sensing hole 110b may be formed approximately at the center of the first suction part 110, and one or more second sensing holes 110c may be formed at positions spaced apart from the first sensing hole 110b; however, the scope of the present disclosure is not limited thereto. In this configuration, the first sensing hole 110b can provide a path or passage through which an electrode sensing element 151 of the first sensing part 150 to be described below senses whether an electrode 9 is present on the first suction part 110. Further, the second sensing hole 110c can provide a path or passage through which the multi-sheet sensing element 153 of the first sensing part 150 senses whether two or more sheets of electrodes 9 are placed on the first suction part 110.

The lower surface of the first suction part 110 can be, for example, supported by a frame F on the position alignment part 160. The frame F, for example, may be spaced apart in a second direction as a pair to perform a leg function for supporting the first suction part 110. The frame F, for example, may have its lower surface disposed on the position alignment part 160 and can support the lower surface of the first suction part 110 with its upper surface such that the position alignment part 160 and the first suction part 110 are connected to each other.

Further, the first suction part 110 may include a suction plate 111 and a light transmission plate 113.

The suction plate 111 is formed on one side of the first suction part 110, preferably at a center of the first suction part 110, and is configured to vacuum-suction an electrode 9 placed on its upper side. Further, the aforementioned first sensing hole 110b and second sensing hole 110c are preferably formed in the suction plate 111. Further, the suction plate 111 may have the multiple suction holes 110a formed therein, and is preferably made of an opaque material, but the present disclosure is not limited thereto. Hereinafter, the suction holes 110a formed in the suction plate 111 are referred to as first suction holes 111a.

The light transmission plate 113 is formed at one end or both ends of the first suction part 110 in the first direction to transmit light emitted toward the image-capturing part 120 positioned thereunder. The upper surface of the light transmission plate 113 is preferably disposed at substantially the same height as the upper surface of the suction plate 111 so that the upper surface of the first suction part 110 is formed substantially flat. Further, for example, the light transmission plate 113 may be disposed as a pair spaced apart from each other in the first direction with the first suction part 110 therebetween.

Further, the light transmission plate 113 is preferably made of a transparent material on at least one of its upper surface and lower surface to transmit light, and more preferably, its front surface is made of a transparent material. For example, at least one of the upper surface and lower surface of the light transmission plate 113 may be made of polycarbonate (PC), but the present disclosure is not limited thereto, and it should be noted that the light transmission plate 113 may be made of any known material suitable for transmitting light emitted toward the image-capturing part 120.

Further, it is preferable that the suction holes 110a are formed in the light transmission plate 113 in order to firmly fix the ends of the electrode 9 at correct positions on the first suction part 110. Hereinafter, the suction holes 110a formed in the light transmission plate 113 are referred to as second suction holes 113a. By firmly fixing the ends of the electrode 9 through the second suction holes 113a formed in the light transmission plate 113, the accuracy of image-capturing information acquired through the image-capturing part 120 can be improved.

The second suction holes 113a may be in communication with the first suction holes 111a. That is, a vacuum line (not shown) connected to the second suction holes 113a may be connected to the vacuum line of the first suction holes 111a. Alternatively, the second suction holes 113a may not be in communication with the first suction holes 111a. That is, the vacuum line connected to the first suction holes 111a and the vacuum line connected to the second suction holes 113a may be physically separate vacuum lines. Therefore, the first suction holes 111a, which vacuum-suction the body of the electrode 9, and the second suction holes 113a, which vacuum-suction the ends of the electrode 9, can fix the electrode 9 on the first suction part 110 at different vacuum pressures, or can fix the electrode 9 on the first suction part 110 at substantially the same vacuum pressure.

Further, the light transmission plate 113 may include an fiducial mark formed on its upper and/or lower surface to provide a reference position to the image-capturing part 120 and/or the control part 180. The fiducial mark has a pattern of which an image can be captured through the image-capturing part 120, and the pattern may have various known forms.

Referring to FIGS. 2 to 3, the image-capturing part 120 is disposed under the first suction part 110 to capture an image of the electrode 9 seated on the first suction part 110. For example, the image-capturing part 120 can capture an image of the edge and/or an end in the first direction of the electrode 9. Further, after capturing an image of the electrode 9, the image-capturing part 120 can send the image-capturing information to the control part 180. Then, the control part 180 can drive the position alignment part 160 on the basis of the acquired image-capturing information to align the position of the electrode 9, and detailed description thereof will be provided below. Further, the image-capturing part 120 may be disposed under the first suction part 110 at a position corresponding to the light transmission plate 113. That is, the image-capturing part 120 may be disposed at a position vertically overlapping the light transmission plate 113 so that light is emitted to the light transmission plate 113. In this case, when a pair of light transmission plates 113 spaced apart from each other is disposed in the first direction, the image-capturing part 120 may also be installed at positions one-to-one corresponding to the individual light transmission plates 113.

To this end, the image-capturing part 120 may include an image-capturing device 121 and a fixing part 123.

The image-capturing device 121 is a component capturing an image of the electrode 9 placed on the first suction part 110 and can emit light upward. The image-capturing device 121, for example, may be a vision camera, but the present disclosure is not limited thereto, and it should be noted that any known image-capturing devices suitable for capturing an image of the electrode 9 on the first suction part 110, preferably the electrode 9 on the light transmission plate 113, may be utilized. The light path L according to the image-capturing device 121 is as illustrated in FIGS. 2 and 3.

The fixing part 123 is coupled to the image-capturing device 121 to fix the image-capturing device 121 at a correct position. For example, the fixing part 123 may include a vertical plate member 1231 coupled to a side of the image-capturing device 121 and extending in the vertical direction, and a horizontal plate member 1233 coupled to the vertical plate member 1231. Further, the horizontal plate member 1233 may be coupled to one side of the first movement guide part 140 to be described below. Thus, since the fixing part 123 is connected to the first movement guide part 140, the image-capturing device 121 can be adjusted in position in the first direction, and detailed description thereof will be provided below.

The lighting part 130 is disposed adjacent to the first suction part 110, preferably adjacent to the light transmission plate 113, and includes a light that assists the image-capturing part 120 in capturing an image of the electrode 9 on the light transmission plate 113.

To this end, the lighting part 130 may include a lighting device 131 and a supporting member 133.

The lighting device 131 is a lighting configuration disposed adjacent to and under the light transmission plate 113 and one or more lighting devices may be provided. For example, multiple lighting devices 131 may be arranged to be spaced apart along the periphery of the corresponding light transmission plate 113. For example, when the light transmission plate 113 has a rectangular plate shape, a total of three lighting devices 131 may be disposed to be spaced apart from each other while being spaced apart from the three exposed sides of the light transmission plate 113. Further, each of the lighting devices 131 may be arranged to be inclined at a predetermined angle from the floor to face the corresponding light transmission plate 113. Accordingly, light emitted from the lighting device 131 can be directed toward the corresponding light transmission plate 113. It should be noted that, in this case, the lighting devices 131 may be arranged at different angles from a bottom plate, depending on whether the electrode 9 that is placed on the first suction part 110 is a negative plate or a positive plate. Further, the lighting device 131 may be, for example, an LED light, but the present disclosure is not limited thereto.

The supporting member 133 is configured such that the lighting device 131 is disposed on its upper surface, and, for example, may have a plate shape. Further, one or more members may be stacked under the supporting member 133 so that the supporting member 133 is connected to the first movement guide part 140. Accordingly, the lighting device 131 may also be adjustable in position in the first direction.

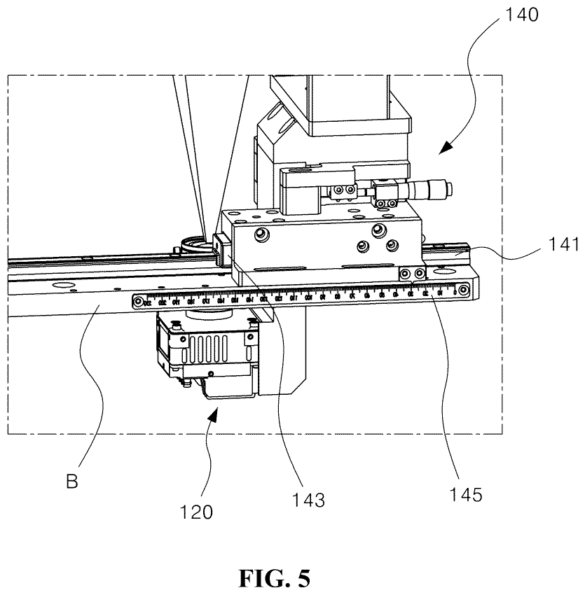

FIG. 5 is an illustrative view of a movement guide part according to FIG. 2.

Referring to FIGS. 2 to 3 and 5, the first movement guide part 140 is formed at the lower portion of the alignment unit 10 to control movement of the image-capturing part 120 and/or the lighting part 130 in the first direction. That is, the first movement guide part 140 allows the image-capturing part 120 and/or the lighting part 130 to be adjusted in position in the first direction. For example, when the image-capturing part 120 and/or the lighting part 130 are each provided in a pair to be spaced apart from each other in the first direction, the first movement guide part 140 may also be provided in a pair to be spaced apart from each other in the first direction to control movement of the corresponding image-capturing part 120 and/or lighting part 130 in the first direction.

To this end, the first movement guide part 140 may include a first guide rail 141, a first linear guide 143, and a scale marking portion 145.

The first guide rail 141 is a rail extending in the first direction and may be disposed on a base member B. The base member B has a plate shape extending in the first direction, and the first guide rail 141 and/or the position alignment part 160 may be disposed on the base member B. Further, when a pair of first movement guide parts 140 is provided to be spaced apart from each other in the first direction, the pair of first movement guide parts 140 may share the first guide rail 141, or the pair of first guide rails 141 may be spaced apart from each other in the first direction, and the present disclosure is not limited thereto.

The first linear guide 143 may be coupled to the first guide rail 141 to move in the first direction. The first linear guide 143 can move in the first direction under control of the control part 180 or by manual operation by an operator. The first linear guide 143 may be connected to the image-capturing part 120 and/or the lighting part 130. For example, the horizontal plate member 1233 may be disposed on the upper surface of the first linear guide 143, and the supporting member 133 or one or more members stacked under the supporting member 133 may be disposed on the horizontal plate member 1233. However, it should be noted that the connection between the first linear guide 143 and the image-capturing part 120 and/or the lighting part 130 is not limited to the above example.

The scale marking portion 145 is formed on one surface of the base member B so that the movement extent of the first linear guide 143 is visually checked. Multiple scales may be formed to be spaced apart from each other in the first direction on the scale marking portion 145. The scale marking portion 145 may be formed on one surface of the base member B, for example by laser engraving or printing, and is not limited thereto.

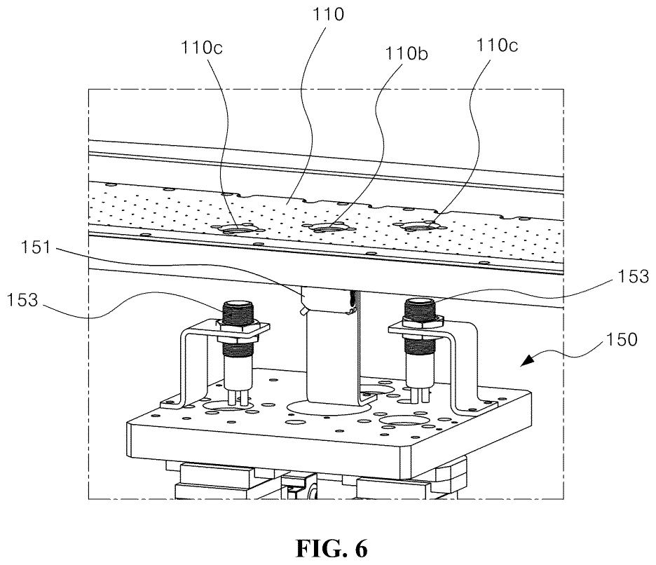

FIG. 6 is an illustrative view of a sensing part according to FIG. 2.

Referring to FIGS. 2 to 3 and 6, the first sensing part 150 is formed under the first suction part 110 to perform sensing of an electrode 9 seated on the first suction part 110. To this end, the first sensing part 150 may include an electrode sensing element 151 and a multi-sheet sensing element 153.

The electrode sensing element 151 is disposed under the first suction unit 110, preferably between a pair of frames F to sense whether an electrode 9 is present on the first suction unit 110. Further, the electrode sensing element 151 is preferably disposed immediately under the first sensing hole 110b. The electrode sensing element 151, for example, may be an optical sensor, but the scope of the present disclosure is not limited thereto.

The multi-sheet sensing element 153 is disposed under the first suction unit 110, preferably between a pair of frames F to sense whether two or more sheets of electrodes 9 are on the first suction unit 110. For example, when two or more sheets of electrodes 9 are seated on the first suction part 110 at once, it may cause defects in subsequent processes such as a stacking process. To prevent this, an alignment unit 10 according to an embodiment of the present disclosure is characterized by including the multi-sheet sensing element 153. Further, it is preferable that the multi-sheet sensing element 153 is disposed immediately under the second sensing hole 110c. The multi-sheet sensing element 153, for example, may be an ultrasonic sensor, but the scope of the present disclosure is not limited thereto.

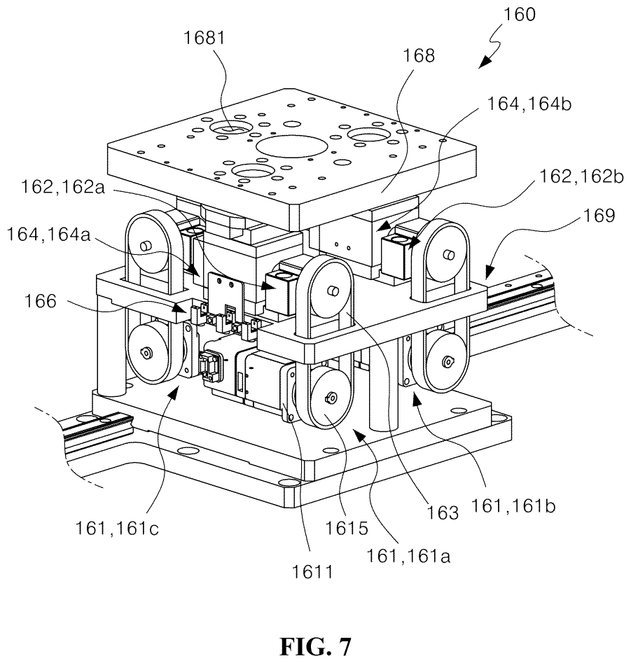

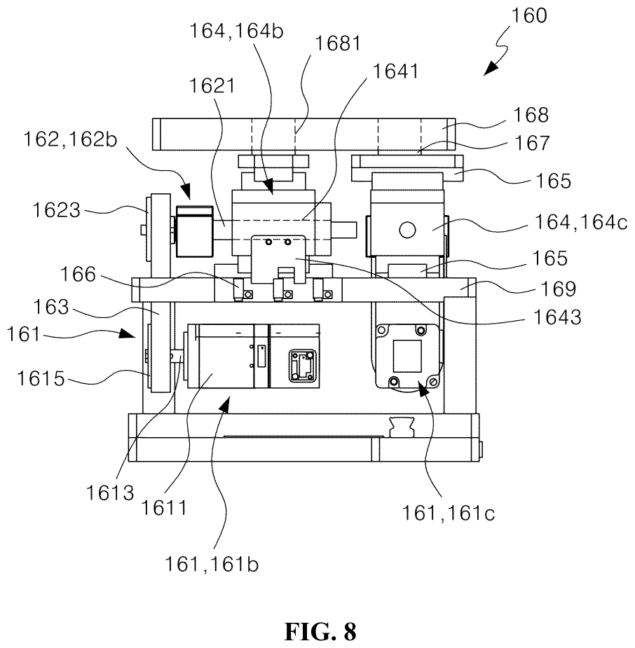

FIG. 7 is a perspective view of a position alignment part according to FIG. 2 and FIG. 8 is a side view of the position alignment part according to FIG. 2.

Referring to FIGS. 2 to 3 and 7 to 8, the position alignment part 160 is configured to align the position of an electrode 9 on the first suction part 110 by adjusting the position of the first suction part 110. For example, the position alignment part 160 can perform xyθ control of the position of the electrode 9 on the first suction part 110. The θ control refers to controlling the rotational angle of the electrodes 9 in the horizontal direction by adjusting the positions of the first suction part 110 along the x-axis and y-axis. The position alignment part 160 can be connected to the first suction part 110 through the frame F under the first suction part 110. Further, the position alignment part 160 can be driven by the control part 180. Further, it is preferable that the position alignment part 160 has a two-stage stacked structure.

To this end, the position alignment part 160 may include a drive part 161, a movement control part 162, a belt 163, a moving part 164, a second movement guide part 165, a second sensing part 166, a rotary part 167, and an upper plate member 168. In this configuration, the drive part 161 is preferably disposed under the movement control part 162 and the moving part 164.

The drive part 161 is configured to control the rotation of one side of the corresponding movement control part 162. Although not shown in the drawings, the drive part 161 may be fixedly installed on the base member B or an intermediate plate member 169. For example, three drive part 161 may be arranged, and for example, a first drive part 161a and a second drive part 161b may be disposed in the first direction, and a third drive part 161c may be disposed in the second direction. In this case, the first drive part 161a and the second drive part 161b are preferably spaced apart from each other in the second direction. Conversely, it is also possible that the first drive part 161a and the second drive part 161b are disposed in the second direction, and the third drive part 161c is disposed in the first direction.

Further, the drive part 161 may include a drive element 1611, a rotary shaft 1613, and a lower pulley 1615.

The drive element 1611 is configured to control the rotation of the rotary shaft 1613. The drive element 1611, for example, may be a servo motor, but the scope of the present disclosure is not limited thereto.

The rotary shaft 1613 is connected to the respective drive element 1611, and its end is coupled to the respective lower pulley 1615. For example, the rotary shafts 1613 of the first drive part 161a and the second drive part 161b may extend in the first direction, and the rotary shaft 1613 of the third drive part 161c may extend in the second direction.

Further, the rotary shaft 1613 can be coupled to the respective lower pulley 1615.

The movement control part 162 is disposed be one-to-one matched with the respective drive part 161 to receive a driving force from the drive part 161 and control the horizontal movement direction of the moving part 164. Although not shown in the drawings, the movement control part 162 may be fixedly installed on the intermediate plate member 169 between the drive part 161 and the moving part 164. For example, three movement control parts 162 may be disposed. For example, a first movement control part 162a, a second movement control part 162b, and a third movement control part 162c may be connected to the respective first drive part 161a, second drive part 161b, and third drive part 161c through the belts 163, respectively.

Further, the movement control part 162 may include a movement control shaft 1621 and an upper pulley 1623.

The movement control shaft 1621 is a shaft member extending in the same direction as the rotary shaft 1613 of the corresponding drive part 161. Further, the movement control shaft 1621, for example, may be a ball screw, and a ball screw nut (not shown) may be coupled to its outer surface or outer periphery. The movement control shaft 1621 may be inserted into the corresponding moving part 164.

The upper pulley 1623 is coupled to the respective movement control shaft 1621 and can be connected to the corresponding lower pulley 1615 through the belt 163. Therefore, when the lower pulley 1615 rotates, the corresponding upper pulley 1623 can also rotate. When the upper pulley 1623 rotates, the corresponding movement part 164 can move forward and backward by the rotation of the corresponding movement control shaft 1621

The part 164 is disposed adjacent to the respective movement control part 162 to move horizontally in the longitudinal direction of the corresponding movement control shaft 1621. For example, the first movement part 164a and the second movement part 164b can move in the first direction, and the third movement part 164c can move in the second direction. In this case, the first movement part 164a and the second movement part 164b may be spaced apart from each other in the second direction.

A shaft insertion hole 1641 may be formed at the moving part 164 so that the corresponding movement control shaft 1621 can be inserted therein. Further, a sensing member 1643 may be fixedly installed on one surface of the moving part 164. The sensing member 1643 can pass through one side of the corresponding second sensing part 166 to allow the second sensing part 166 to sense the horizontal movement extent of the corresponding moving part 164.

The second movement guide part 165 is disposed on the upper and/or lower surface of the respective moving part 164 to guide the horizontal movement of the respective moving part 164. For example, the second movement guide part 165 may be disposed on the intermediate plate member 169 between the drive part 161 and the moving part 164. Further, the second movement guide part 165 may be disposed on the upper surface of the moving part 164 so that the upper surface of the corresponding moving part 164 is inserted therein. The second movement guide part 165 may be formed in a rail shape, but the scope of the present disclosure is not limited thereto

When the second movement guide part 165 positioned over the respective moving part 164 has a form extending in the first direction to enhance the xyθ-control accuracy of the position of the electrode 9 on the first suction part 110 by the position alignment part 160, the second movement guide part 165 positioned under the respective moving part 164 may have a form extending in the second direction. That is, a pair of second movement guide parts 165 may have a form extending in directions crossing each other. For reference, the second movement guide part 165 positioned under the respective moving part 164 may be a first movement guide rail, and the second movement guide part 165 positioned over the respective moving part 164 may be a second movement guide rail.

The second sensing part 166 is disposed adjacent to the respective moving part 164 to sense the horizontal movement extent of the corresponding moving part 164. For example, the second sensing part 166 may be a micro photoelectric sensor, but the scope of the present disclosure is not limited thereto. Further, the second sensing part 166 may be disposed on one surface of the intermediate plate member 169.

The rotary part 167 is disposed on the corresponding moving part 164 or second movement guide part 165, and its upper portion is inserted in the corresponding insertion hole 1681 of a top plate member 168. The rotary part 167, for example, may be formed in a cylindrical shape and may be installed to be rotatable in the horizontal direction between the top plate member 168 and the second movement guide part 165.

The top plate member 168 is disposed at the uppermost end of the position alignment part 160 to move in any one or more directions of the first direction, the second direction, and the horizontal rotational direction in response to the driving of the respective drive part 161. The top plate member 168 may be connected to the first suction part 110 through a frame F positioned over it. Three insertion holes 1681 in which the rotary parts 167 are respectively inserted may be formed at the top plate member 168.

Hereinafter, the operation of the position alignment part 160 is described in detail.

First, when the first rotary shaft 1613a and the second rotary shaft 1613b rotate in the same direction, the first moving part 164a and the second moving part 164b can advance or retract in the first direction, whereby the top plate member 168 can advance or retract in the first direction. Further, when the third rotary shaft 1613c rotates, the third moving part 164c can advance or retract in the second direction, whereby the top plate member 168 can advance or retract in the second direction. Further, when the first rotary shaft 1613a and the second rotary shaft 1613b rotate in opposite directions, the first moving part 164a and the second moving part 164b can advance and retract, respectively, in the first direction. In addition, the third moving part 164c can also move in the second direction. In this case, the respective rotary part 167 rotates, and the top plate member 168 in which the rotary part 167 is inserted can also rotate by a predetermined angle.

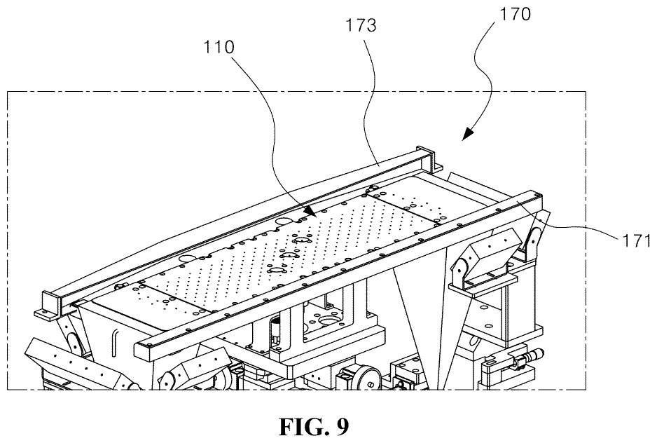

FIG. 9 is an illustrative view of a foreign matter removal part according to FIG. 2.

Referring to FIGS. 2 to 3 and 9, the foreign matter removal part 170 is configured to remove various foreign matter attached to the first suction part 110 by discharge fluid onto the first suction part 110. That is, the foreign matter removal part 170 sprays fluid onto the first suction part 110 before an electrode 9 is placed on the first suction part 110. The term “fluid” refers to gas, and, for example, may be air, but the scope of the present disclosure is not limited thereto. Further, the foreign matter removal part 170 may include a fluid spraying part 171 and a collecting part 173.

The fluid spraying part 171 is disposed at one side of the first suction part 110 to spray fluid onto the first suction part 110. Further, the fluid spraying part 171 can be disposed to be spaced apart from the collecting part 173 in the second direction. More specifically, the first suction part 110 may be positioned between the fluid spraying part 171 and the collecting part 173. Moreover, it is preferable that the fluid spraying part 171 is elongated in the first direction, and it is more preferable that the fluid spraying part 171 has a width in the first direction greater than that of the first suction part 110.

The collecting part 173 is disposed at another side of the first suction part 110 to suction foreign matter, etc. that are removed from the first suction part 110. It is preferable that the collecting part 173 is elongated in the first direction, and it is more preferable that the collecting part 173 has a width in the first direction greater than that of the first suction part 110. Further, the side of the collecting part 173 facing the first suction part 110 is open, so foreign matter, etc. can be collected along the inside of the collecting part 173.

Referring to FIGS. 2 to 3, the control part 180 is configured to acquire image-capturing information from the image-capturing part 120 and to control the driving of the position alignment part 160. For example, the control part 180 can store reference coordinate information regarding the correct position of an electrode 9 that is placed on the first suction part 110. Accordingly, the control part 180 can determine the driving extent of the position alignment part 160 by comparing the reference coordinate information with the image-capturing information acquired from the image-capturing part 120. Further, the control part 180 may store reference shape information of an electrode 9 that is placed on the first suction part 110. Therefore, the control part 180 can control the operation of the discharge unit 30 by comparing the reference shape information with the image-capturing information acquired from the image-capturing part 120.

Here, if an electrode 9 cannot be aligned within the driving range of the position alignment part 160, the control part 180 can control the operation of the discharge unit 30 to discharge the electrode 9.

Further, the control part 180 may control the movement and the movement distance in the first direction of one side of the first movement guide part 140.

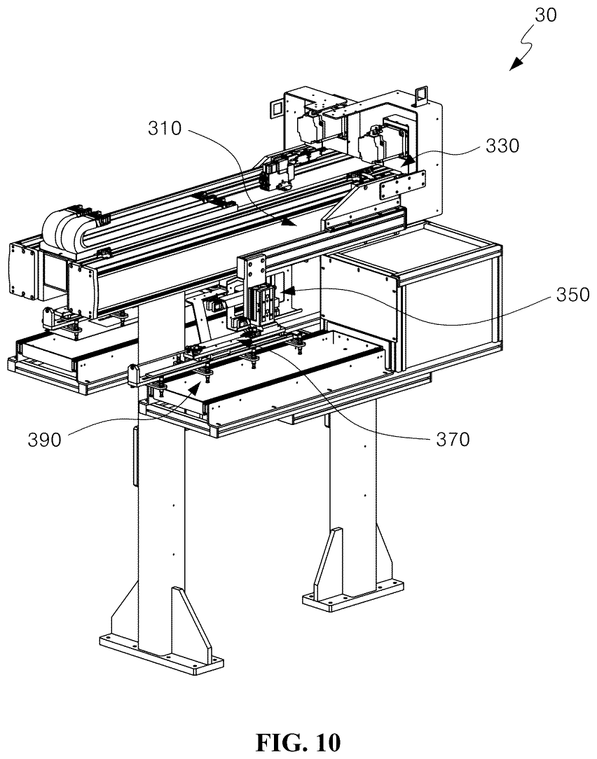

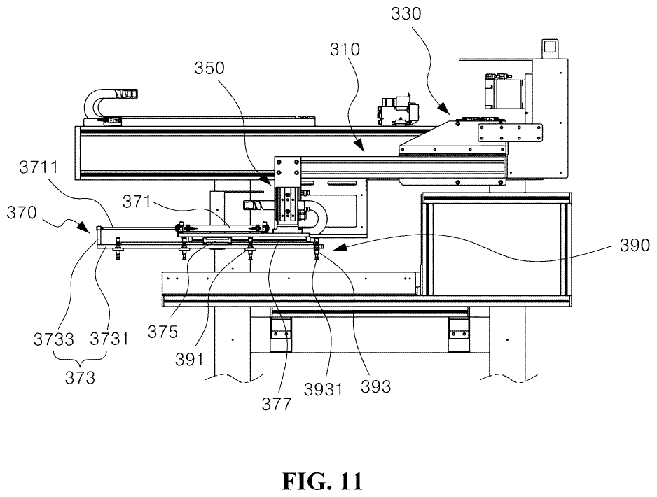

FIG. 10 is a perspective view of a discharge unit according to FIG. 1 and FIG. 11 is a front view of the discharge unit according to FIG. 10.

Referring to FIGS. 10 to 11, the discharge unit 30 is configured to discharge an electrode 9 to the outside of the alignment unit 10 when a defective condition is detected in the electrode 9 on the alignment unit 10. The term “detection of a defective condition” is understood to mean a case in which the position alignment of an electrode 9 placed on the first suction part 110 has failed, a case in which an abnormality has occurred in the shape of the electrode 9, and/or a case in which it has been sensed by the first sensing part 150 that two or more sheets of electrodes 9 are placed on the first suction part 110. Here, the case in which the position alignment of the electrode 9 placed on the first suction part 110 has failed can be understood to mean that tilting of the electrode 9 on the first suction part 110 exceeds the driving range of the position alignment part 160, so it is impossible to align the electrode 9.

To this end, the discharge unit 30 may include a first drive actuator 310, a moving part 330, a second drive actuator 350, a position adjustment part 370, and a second suction part 390.

The first drive actuator 310 is configured to control the movement of the moving part 330 in the first direction. For example, one side of the first drive actuator 310 may be coupled to the moving part 330. Further, the first drive actuator 310 may be, for example, a hydraulic cylinder or a pneumatic cylinder, but is not limited thereto, and may be a known drive unit for controlling the movement of the moving part 330 in the first direction.

The moving part 330 is configured to be moved in the first direction by the driving of the first drive actuator 310. The moving part 330 may be connected to the second drive actuator 350 and the second suction part 390. By the movement of the moving part 330 in the first direction, the second suction part 390 can move above the first suction part 110 or can move away from the first suction part 110. For this purpose, one side of the moving part 330 may be coupled to a rail extending in the first direction.

The second drive actuator 350 is coupled to the moving part 330 to control the vertical movement of the second suction part 390. The second drive actuator 350 may be, for example, a hydraulic cylinder or a pneumatic cylinder, but is not limited thereto, and may be a known drive unit for controlling the vertical movement of the second suction part 390.

The position adjustment part 370 controls the movement of the second suction part 390 in the first direction, thereby finely adjusting the position of the second suction part 390 in the first direction. When the position adjustment part 370 operates, only the second suction part 390 can move in the first direction independently of the moving part 330. To this end, the position adjustment part 370 may include a third drive actuator 371, a fixing member 373, a second linear guide 375, and a second guide rail 377.

The third drive actuator 371 extends in the first direction to control the movement of the second suction part 390 in the first direction. The third drive actuator 371, for example, may be a hydraulic cylinder or a pneumatic cylinder, but the present disclosure is not limited thereto, and it may be a known drive unit that controls the movement of the second suction part 390 in the first direction. Further, a drive shaft 3711 may be formed at an end of the third drive actuator 371. The drive shaft 3711 extends in the first direction, and its end may be fixed to the fixing member 373.

The fixing member 373 has one side configured to fix an end of the drive shaft 3711 of the third drive actuator 371. The fixing member 373 may include a base plate member 3731 and a fixing plate member 3733.

The base plate member 3731 is configured such that the second linear guide 375 to be described below is disposed on its upper surface, and, for example, may have a plate shape.

The fixing plate member 3733 extends upward from the upper surface of the base plate member 3731 to fix an end of the drive shaft 3711. To this end, an insertion groove 3733a for inserting the drive shaft 3711 may be formed at the upper end of the fixing plate member 3733.

The second linear guide 375 is disposed at one side of the fixing member 373, preferably on the upper surface of the base plate member 3731, and is coupled to the second guide rail 377 above it. Therefore, when the second linear guide 375 moves in the first direction, the second suction part 390 can move in the first direction along the second guide rail 377.

The second guide rail 377 is a rail extending in the first direction. As described above, the second guide rail 377 may be elongated in the first direction.

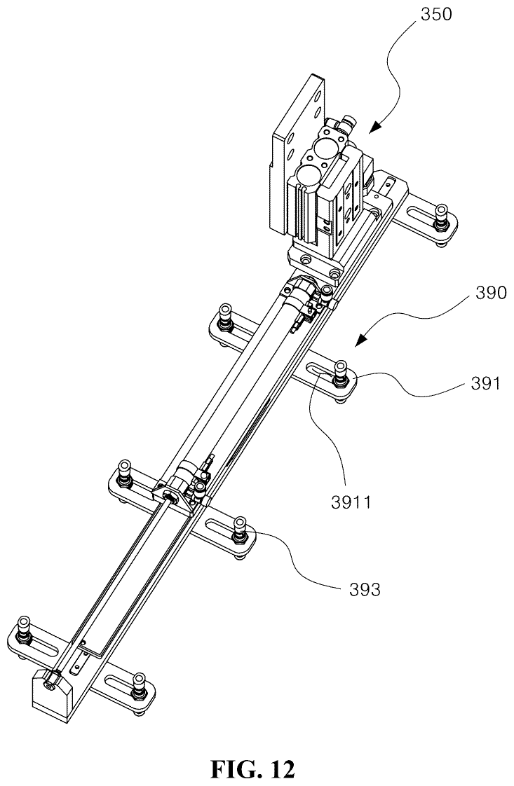

FIG. 12 is a plan view of a second suction part according to FIG. 10.

Referring to FIGS. 10 to 12, the second suction part 390 is connected to the second drive actuator 350 and the position adjustment part 370 to vacuum-suction the electrode 9 positioned thereunder. To this end, the second suction part 390 may include a connecting member 391 and a suction member 393.

The connecting member 391 is configured to fix the suction member 393 at a correct position, and, for example, may be disposed on the lower surface of the bottom plate member 3731. Further, an elongated slot 3911 extending in the second direction may be formed at the connecting member 391, and the suction member 393 can be inserted and fixed in the slot 3911. Therefore, the position of the suction member 393 in the second direction can be adjusted in accordance with the size and/or shape of an electrode 9. Furthermore, it is preferable that multiple connecting members 391 are spaced apart from each other in the first direction so that multiple suction members 393 are fixed.

The suction member 393 is coupled to the connecting member 391 to vacuum-suction the electrode 9 positioned thereunder. To this end, a vacuum pad 3931 may be formed at the lower end of the suction member 393.

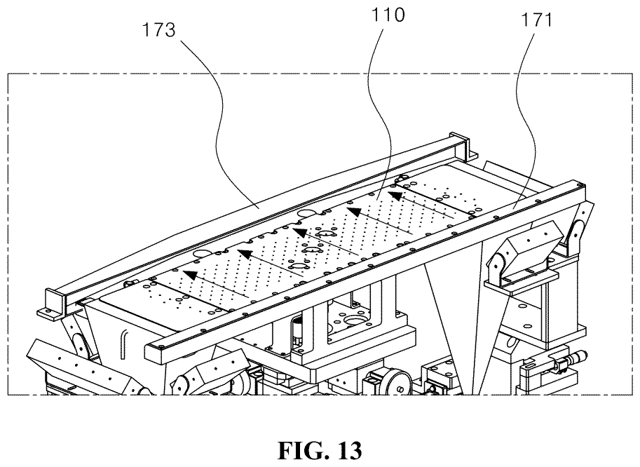

FIGS. 13 to 17 are illustrative views for explaining an electrode alignment method of a secondary battery according to an embodiment of the present disclosure.

Hereinafter, an electrode alignment method of a secondary battery according to an embodiment of the present disclosure is described in detail with reference to the accompanying drawings.

Referring to FIG. 13, first, before an electrode 9 is seated on the first suction part 110, foreign matter remaining on the first suction part 110 is removed by the foreign matter removal part 170. In detail, fluid is discharged toward the first suction part 110 through the fluid spraying part 171, and the foreign matter removed from the first suction part 110 can be collected into the collecting part 173.

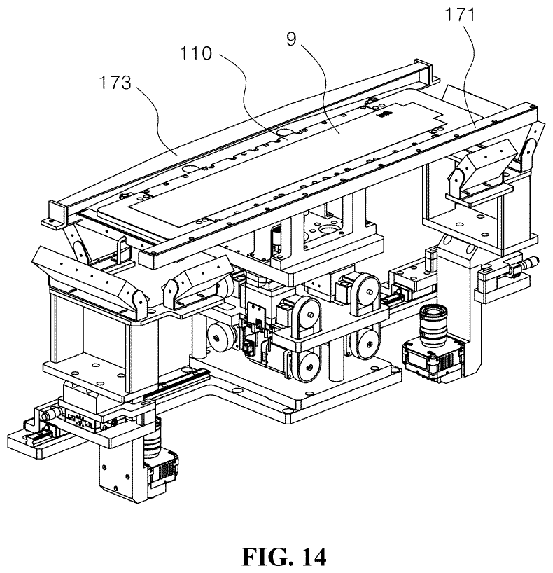

Referring to FIG. 14, thereafter, the electrode 9 can be seated onto the first suction part 110. The electrode 9 can be seated onto the first suction part 110 through an electrode transfer unit (not shown) such as a conveyor or a pick-and-place device. In this case, the electrode sensing element 151 can check whether the electrode 9 is seated on the first suction part 110 through the first sensing hole 110b. When it is determined by the electrode sensing element 151 that the electrode 9 is not seated on the first suction part 110, the electrode transfer unit can perform an operation to transfer the electrode 9 onto the first suction part 110.

Further, it is possible to check whether two or more sheets of electrodes are placed on the first suction part 110. For example, the multi-sheet sensing element 153 can check whether two or more sheets of electrodes 9 are present on the first suction part 110 through the first sensing hole 110b.

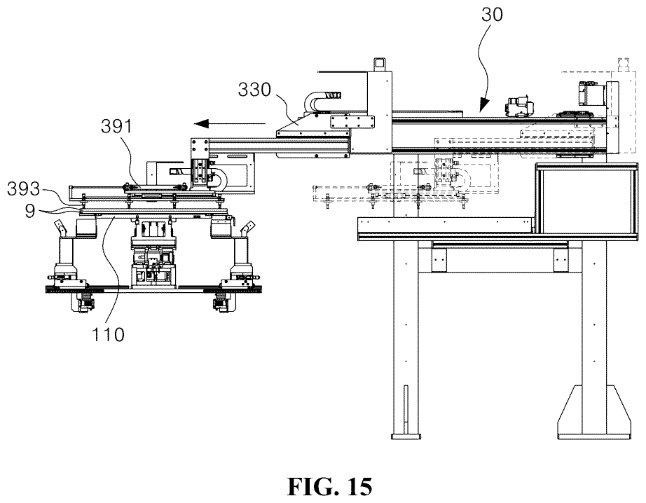

Referring to FIG. 15, when two or more sheets of electrodes 9 are present on the first suction part 110, all of the two or more sheets of electrodes 9 or only unnecessary electrodes 9 can be discharged to the outside through the discharge unit 30. Specifically, one side of the discharge unit 30 can approach the upper side of the electrodes 9 and vacuum-suction the electrodes 9 so that the electrodes 9 are discharged from the alignment unit 10 in the first direction.

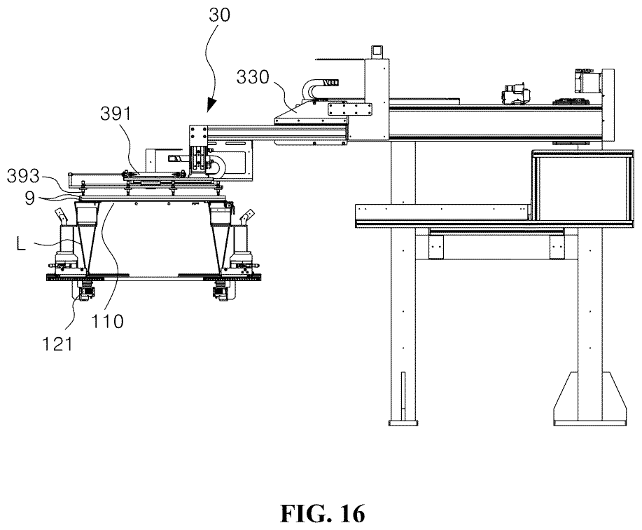

Referring to FIG. 16, when only a single electrode 9 is seated on the first suction part 110, an end of the electrode 9 in the first direction on the light transmission plate 113 of the first suction part 110 can be imaged through the image-capturing device 121, and the image-capturing information can be transmitted to the control part 180. Before capturing an image through the image-capturing part 120, the positions of the image-capturing part 120 and the lighting part 130 in the first direction can be adjusted by the first movement guide part 140.

Further, the control part 180 can control the driving of the alignment part 160 to adjust the horizontal position of the first suction part 110. That is, the electrode 9 on the first suction part 110 is aligned to a preset correct position by the position alignment part 160.

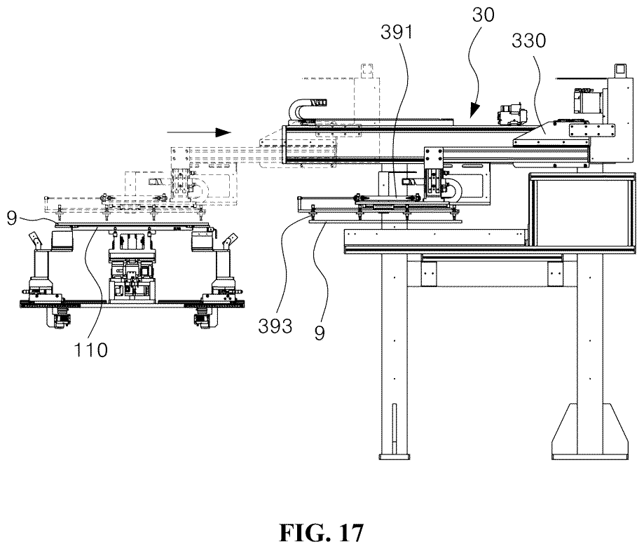

Referring to FIG. 17, when the position alignment of the electrode 9 by the position alignment part 160 fails, one side of the discharge unit 30 can approach the upper side of the electrode 9 and vacuum-suctions the electrode 9 so that the electrode 9 is discharged from the alignment unit 10 in the first direction. Here, failure of the position alignment can be understood as tilting of the electrode 9 seated on the first suction part 110 exceeding the driving range of the alignment part 160.

The specification described above provides examples of the present disclosure. Further, the description provides an embodiment of the present disclosure and the present disclosure may be used in other various combination, changes, and environments. That is, the present disclosure may be changed or modified within the scope of the present disclosure described herein, a range equivalent to the description, and/or within the knowledge or technology in the related art. The embodiment shows an optimum state for achieving the spirit of the present disclosure and may be changed in various ways for the detailed application fields and use of the present disclosure. Therefore, the detailed description of the present disclosure is not intended to limit the present disclosure in the embodiment.

What is claimed is:

1. An electrode alignment unit of a secondary battery, comprising:
a first suction part configured to vacuum-suction an electrode seated on one surface;
an image-capturing part configured to capture an image of an electrode on the first suction part;
a position alignment part configured to align the position of an electrode seated on the first suction part by adjusting the position of the first suction part; and
a control part configured to control driving of the position alignment part.

2. The electrode alignment unit of a secondary battery of claim 1, wherein the first suction part comprises:
a suction plate disposed at a center of the first suction part and configured to vacuum-suction an electrode placed on an upper side thereof; and
a light transmission plate disposed at an edge and/or an end of the first suction part in one direction and configured to vacuum-suction the electrode.

3. The electrode alignment unit of a secondary battery of claim 2, wherein the suction plate comprises multiple first suction holes on an upper surface, and
the light transmission plate comprises one or more second suction holes on an upper surface thereof.

4. The electrode alignment unit of a secondary battery of claim 3, wherein the image-capturing part captures an image of the electrode seated on the light transmission plate.

5. The electrode alignment unit of a secondary battery of claim 2, wherein the image-capturing part comprises:
an image-capturing device disposed under the light transmission plate and configured to capture an image of an electrode on the light transmission plate;
a fixing member coupled to the image-capturing device and configured to fix the image-capturing device at a correct position; and
a lighting part of a lighting configuration configured to assist in capturing an image of an electrode on the light transmission plate.

6. The electrode alignment unit of a secondary battery of claim 2, comprising multiple lighting devices spaced apart from each other adjacent to and under the light transmission plate and disposed to be inclined at a predetermined angle from a floor.

7. The electrode alignment unit of a secondary battery of claim 1, further comprising a first movement guide part configured to control movement of the image-capturing part in one direction,
wherein the first movement guide part comprises:
a first guide rail of a rail configuration extending in one direction; and
a first linear guide coupled to the first guide rail and configured to move together with the image-capturing part in one direction.

8. The electrode alignment unit of a secondary battery of claim 1, wherein the position alignment part comprises:
a drive part;
a movement control part disposed over the drive part and configured to receive a driving force from the drive part;
a moving part disposed over the drive part and configured to be moved in a horizontal direction by the movement control part; and
a second movement guide part disposed on an upper surface and/or a lower surface of the moving part and configured to guide horizontal movement of the moving part.

9. The electrode alignment unit of a secondary battery of claim 8, wherein the position alignment part further comprises:
a rotary part rotatably disposed on the moving part or the second movement guide part; and
a top plate member having an insertion hole in which an upper portion of the rotary part is inserted,
wherein the top plate member is connected to the first suction part.

10. The electrode alignment unit of a secondary battery of claim 8, wherein the second movement guide part comprises:
a first movement guide rail on an upper surface of the moving part; and
a second movement guide rail on a bottom surface of the moving part,
wherein the first movement guide rail extends in a direction crossing the second movement guide rail.

11. The electrode alignment unit of a secondary battery of claim 1, wherein the control part controls driving of the position alignment part by comparing image-capturing information acquired from the image-capturing part with reference coordinate information stored in the control part.

12. The electrode alignment unit of a secondary battery of claim 1, further comprising a sensing part configured to sense an electrode seated on the first suction part,
wherein the sensing part comprises an electrode sensing element configured to sense whether an electrode is present on the first suction part.

13. The electrode alignment unit of a secondary battery of claim 1, further comprising a sensing part configured to sense an electrode seated on the first suction part,
wherein the sensing part further comprises a multi-sheet sensing element configured to sense whether two or more sheets of electrodes are present on the first suction part.

14. The electrode alignment unit of a secondary battery of claim 1, further comprising a foreign matter removal part configured to remove foreign matter attached to the first suction part,
wherein the foreign matter removal part comprises:
a fluid spraying part disposed at one side of the first suction part and configured to spray fluid onto the first suction part; and
a collecting part disposed at another side of the first suction part and configured to collect foreign matter removed from the first suction part.

15. An electrode alignment system of a secondary battery, comprising:
the electrode alignment unit of a secondary battery of claim 1; and
a discharge unit configured to discharge an electrode on the electrode alignment unit of a secondary battery to the outside when a defective condition is detected in the electrode.

16. The electrode alignment system of a secondary battery of claim 15, wherein the discharge unit comprises:
a first drive actuator;
a moving part configured to be moved in one direction by driving of the first drive actuator;
a second drive actuator coupled to the moving part; and
a second suction part connected to the second drive actuator and configured to be vertically moved by driving of the second drive actuator.

17. The electrode alignment system of a secondary battery of claim 16, wherein the discharge unit further comprises a position adjustment part configured to control movement of the second suction part in one direction,
wherein the position adjustment part comprises:
a third drive actuator;
a fixing member configured to fix an end of a drive shaft of the third drive actuator;
a second linear guide disposed on one surface of the fixing member; and
a second guide rail coupled to the second linear guide.

18. The electrode alignment system of a secondary battery of claim 15, wherein, in any one case of a case in which it is determined that the position alignment part cannot align the position of the electrode seated on the first suction part, a case in which it is determined that there is a problem in the shape of the electrode by comparing image-capturing information acquired from the image-capturing part with reference shape information stored in the control part, and a case in which it is determined that two or more sheets of electrodes are seated on the first suction part, the discharge unit discharges the electrode to the outside from the electrode alignment unit of a secondary battery.

19. An electrode alignment method of a secondary battery by the electrode alignment unit of a secondary battery of claim 1, the method comprising:
fixing an electrode seated on the first suction part by vacuum-suctioning the electrode;
acquiring image-capturing information by capturing an image of the electrode seated on the first suction part through the image-capturing part; and
controlling driving of the position alignment part by comparing the image-capturing information with reference coordinate information through the control part.

20. The electrode alignment method of a secondary battery of claim 19, wherein the electrode alignment unit of a secondary battery further comprises a foreign matter removal part that includes a fluid spraying part disposed at one side of the first suction part and configured to spray fluid onto the first suction part, and a collecting part disposed at another side of the first suction part and configured to collect foreign matter removed from the first suction part; and
the electrode alignment method further comprises removing foreign matter on the first suction part through the foreign matter removal part before vacuum-suctioning an electrode on the first suction part.
